(19) United States
(12) Patent Application Publication
(10) Pub. No.: US 2009/0291415 A1
(43) Pub. Date: Nov. 26, 2009

(54) Device and Method for Gingival Attachment Associated with Endosseous Implants

(75) Inventors: Itzhak Binderman, Tel Aviv (IL); Avinoam Yaffe, Mevasseret Zion (IL); Hila Bahar, Tel Aviv (IL)

Correspondence Address: RICHARD M. GOLDBERG, 25 EAST SALEM STREET, SUITE 419, HACKENSACK, NJ, 07601, US

(73) Assignee: MEDINTAL LTD, Tel Aviv (IL)

(21) Appl. No.: 12/306,405

(22) PCT Filed: Jul. 2, 2007
(86) PCT No.: PCT/IL07/00820

§ 371 Date: Dec. 23, 2008

(30) Foreign Application Priority Data
Jul. 5, 2006 (US) 60818403
Sep. 7, 2006 (IL) 177959

(51) Int. Cl. A61C 13/01

(52) U.S. Cl. 433/200.1; 433/199.1; 433/215

(57) ABSTRACT

A gingival attachment device associated with an endosseous implant, which comprises a cervically located component of a dental implant coated on a gingival facing surface thereof with a biocompatible and non-degradable polymeric scaffold, to which epithelial and connective tissue cells of the gingiva are attachable. The polymeric scaffold may be polyvinylpyrronidole mixed with butyl-methylmethacrylate, silk fibroin fibrous protein polymer mixed with chitosan or with derivatives of chitosan, and polyHEMA and may be coated on all gingival facing surfaces of the cervically located component.

### FIELD OF THE INVENTION

The present invention relates to the field of dental implants. More particularly, the invention relates to a gingival attachment device and method for endosseous implants.

### BACKGROUND OF THE INVENTION

Cell adhesion plays a critical role in embryonic development and in regulating tissue architecture, tissue function and signaling across cell membranes. Cells in tissues are attached to one another by cadherins and to fibrillar protein meshwork, including collagen, fibronectin and fibrin by integrins. Normally, tensile forces are generated between cells and matrices, creating an organizational pattern of tissue. Rigid substrates or matrices support more focal adhesions and stronger tensile forces between the cells and matrices.

C. Chen et al, “Tensegrity and Mechanoregulation: From Skeleton to Cytoskeleton”, Osteoarthritis and Cartilage (1999), 7, 81-94 describe how mechanical stresses that are applied to an entire organism are transmitted to individual cells and are transduced into a biochemical response. Through use of a tensegrity hierarchy model, by which a structure gains its load support function and mechanical stability from continuous tension and local compression, mechanical stress is focused on signal transducing molecules that physically associate with cell surface molecules for anchoring cells to an extracellular matrix (ECM), such as integrins, and with load-bearing elements within the internal cytoskeleton and nucleus. As a result of Wolff's Law whereby cells that continually remodel bone are able to sense changes in mechanical stresses in their local environment, these cells respond by depositing new ECM where needed and by removing existing ECM when not needed.

During tooth eruption, the periodontium consists of marginal gingival tissue, cementum covering the root surface, the periodontal ligaments and the alveolar bone. Normally, bundles of collagen fibers, commonly referred to as Sharpey fibers, are embedded in the cementum along the root. In the cervical part, i.e. between the root and the tooth crown, of the root cementum, the Sharpey fibers extend toward the basal membrane of the gingiva, also creating an anchorage surface for gingival fibroblasts and toward the periosteum along the collagen bundles. The anchored fibroblasts create tensile forces which act along the collagen fibers. This mechanical interrelationship between cells within the ECM has much importance in maintaining the normal structure and function of the periodontium in natural dentition.

Over the past 30 years the replacement of missing teeth with dental implants has become a viable solution to fixed or removable prosthodontics. Implants are placed into the jaw bone, in intimate contact with the crestal jaw bone. When put in function, the implant protrudes from the gingival tissue into the oral cavity. The recipient site is chosen with respect to the hard and soft tissues, ideally resulting in peri-implant tissues that are most resistant to mechanical forces while providing an aesthetic pleasing outcome.

The gingiva is an anatomical and functional complex having a unique shape and topography resulting from tissue adaptation around the teeth. In normal dentition, the inter-dental gingiva that occupies the space coronal to the alveolar crest is attached to the tooth by connective tissue and junctional epithelium. In the incisor area, the inter-dental gingival has a pyramidal shape, and is commonly referred to as the papilla. Z. Wang, “Management of Inter-Dental/Inter-Implant Papilla”, J Clin Periodontol 2005, 32: 831-839 describes the papilla as serving not only as a biological barrier in protecting the periodontal structures by deflecting inter-coronal food debris, but also serves an important role in providing the teeth with an aesthetic appearance. Aesthetic soft-tissue contours are described by a harmoniously scalloped gingival line, the avoidance of an abrupt change in the clinical crown length between adjacent teeth, a convex buccal mucosa of sufficient thickness, and distinct papillae.

A significant aesthetic factor in implant dentistry is the profile of soft tissue, which plays a crucial role in establishing the entire height of papillae. Ideally, the soft tissue profile should be identical to that of the contralateral natural healthy teeth, particularly with respect to the teeth of patients who display the interimplant soft tissue while smiling and speaking.

In dental implants, although the healing of new gingival cells and matrices occurs, the newly grown gingival cells do not adhere to metal and are therefore not normally attracted to the metallic implant. As a result, disoriented gingival tissue surrounding the cervical part of the implant is formed. Moreover, difficulty remains when trying to maintain or create the papilla between two adjacent implants. The connective tissue of the newly grown gingival tissue becomes attached to the periosteal connective tissue of the crestal bone, i.e. the portion of the alveolar bone closest to the oral cavity, causing resorption of the crestal bone. Thus the normal architecture of the teeth and of the papilla cannot be maintained when prior art dental implants are employed.

Since the gingival fibroblasts do not become attached to the metallic material from which implants are made, mainly titanium, the patterned organization of the gingival is different from natural dentition. The lack of a biological bond between the gingival fibroblasts and the implant surface therefore fails to restore the normal marginal gingival form including the papilla. Moreover, the crestal bone usually undergoes gradual remodeling as controlled by cell-ECM and inter-cell tensile forces in the local environment, thereby leading to bone loss. I. Binderman et al, J of Periodontology, 2002; 73:1210-1215, have shown that surgical splitting of the collagen bundles creates a sudden release of strained fibroblasts, thus signaling the initiation of alveolar bone resorption.

Resorption of the inter-implant bone results in loss of inter-implant papillae. The loss of inter-implant papillae in turn leads to an aesthetic deficiency known as “the black hole disease”, which is characterized by a dark triangular void in the normal location of a papilla. Dentists performing periodontal reconstructive surgery are not able to reliably regenerate the papilla adjacent to a dental implant due to the significant difference between the tissue surrounding a natural tooth and that surrounding an implant. Implants lack cement-like structures, and therefore the connective tissue fibers of the peri-implant mucosa are stretched parallel to the implant surface rather than being perpendicularly attached to the root surface, as occurs with respect to natural teeth. Also, most groups of supracrestal fibers, such as gingivo-dental and transseptal fibers, are not found in the gingival tissue surrounding the implant abutment.

There is therefore a need to provide a device which induces a biological bond between the gingiva and a dental implant.

It is an object of the present invention to provide a device which induces a biological bond between the gingiva and a dental implant.

It is an object of the present invention to provide a device which prevents the resorption of peri-implant bone.

It is an additional object of the present invention to provide a device that is adapted to retain the form of the papilla adjacent to a dental implant.

It is an additional object of the present invention to provide a method of gingival management by which an aesthetically pleasing smile can be achieved.

It is yet an additional object of the present invention to provide a dental implant that prevents the manifestation of the black hole disease.

It is yet an additional object of the present invention to provide a dental implant that is long lasting.

Other objects and advantages of the invention will become apparent as the description proceeds.

### SUMMARY OF THE INVENTION

The present invention provides a gingival attachment device associated with an endosseous implant, which comprises a cervically located component of a dental implant coated on a gingival facing surface thereof with a biocompatible and non-degradable polymeric scaffold to which epithelial and connective tissue cells of the gingiva are attachable. The polymeric scaffold is preferably coated on all gingival facing surfaces of the cervically located component.

As referred to herein, the following terms refer to the corresponding relative location of elements of the gingival attachment device:

“cervical”—between the implant crown and implant root;
“coronal”—in a line between the upper and lower jaws, toward the crown of a dental implant;
“apical”—in a line between the upper and lower jaws, toward the implant root;
“interproximal”—between two adjacent teeth;
“lingual”—toward the tongue; and
“buccal”—toward the cheek.

The polymeric scaffold having a thickness ranging from 0.1-2.0 mm promotes the attachment of gingival and periosteal fibroblasts to the cervically located component of the dental implant. As a result of this biointegrated attachment, gingival and periosteal fibroblasts are anchored to the cervically located component, generating tensile forces that are directed toward the cervical and coronal parts of the implant.

While epithelial cells are not attachable to the metallic material of the cervical part of a prior art implant, and therefore the epithelial cells of the gingiva become attached to the periosteal cells of the crestal bone, causing loss of the interproximal papilla and the resorption of the crestal bone due to lack of tensile forces in the gingiva; thus, epithelial cells become attached to the cervically located component of the present invention so that the gingiva and papilla are able to retain their original form.

In one aspect, the polymeric scaffold is selected from the group of polyvinylpyrronidole mixed with butyl-methylmethacrylate, silk fibroin fibrous protein polymer mixed with chitosan or with derivatives of chitosan, and polyHEMA.

In one aspect, the polymeric scaffold is a porous polymeric scaffold.

In one aspect, the polymeric scaffold comprises a primary polymer coating applied to the cervically located component and a secondary coating applied to said primary coating. The secondary coating may be composed of separate coronal and apical portions. The coronal portion may be coated with molecules selected from the group of enamel proteins, fibrin, collagen Type IV, laminin, or fragments thereof, which attract and promote the adherence of epithelial cells thereto. The apical portion may be coated with molecules selected from the group of collagen Type I, fibronectin, fibrin, fragments thereof, RGD or RGDS peptides, and receptors for integrins, to promote the adherence thereto of gingival fibroblasts.

In one aspect, a plurality of radially extending fibers are attached to the polymeric scaffold, e.g. along the entire periphery thereof. The fibers comprise a biocompatible cell adherent selected from the group of collagen, polymer coated with fibronectin, polymer coated with receptors of gingival fibroblast integrins, and a combination thereof.

In one embodiment, the cervically located component is an annular component comprising a metallic frame which is mountable on a cervically located region of an implant post. The inner wall of the frame may be circular or oval. The frame may be made of a metal selected from the group of gold, titanium, palladium, zirconium, and biocompatible alloys.

In one aspect, the frame has a wall of uniform height ranging from 1-6 mm.

In one embodiment, the frame has a non-uniform height. The frame has interproximal portions that have a greater height than a lingual portion and a buccal portion. The coronal edge of the frame is curvilinear, and is formed without any sharp edges. The coronal edge is concave with respect to the lingual and buccal portions, and is convex with respect to the interproximal portions. The height of the buccal portion ranges from 1-3 mm and that of the lingual portion ranges from 2-5 mm. The height of the interproximal portions ranges from 2-7 mm.

The present invention is also directed to a method for gingiva management, comprising the steps of:
a) providing a plurality of gingival attachment devices, each of said devices comprising a metallic annular frame formed with interproximal portions having a greater height than a lingual portion and a buccal portion and with a curvilinear coronal edge, and a biocompatible and non-degradable polymeric scaffold coated on all gingival facing surfaces of said frame, to which epithelial and connective tissue cells of the gingiva are attachable;
b) measuring the crown height of a dental implant;
c) selecting a gingival attachment device having an interproximal portion of a height equal to a value ranging from 40-70 percent of said measured crown height; and
d) mounting said selected attachment device on the post of said implant.

The papilla which is attached to the interproximal portions is therefore generated in similar fashion as the papilla attached to natural teeth, thereby providing an aesthetically pleasing smile without manifestation of the black hole disease.

### BRIEF DESCRIPTION OF THE DRAWINGS

In the drawings:

FIG. 1 is a schematic illustration of a prior art dental implant, showing the occurrence of bone resorption;

FIG. 2 of a dental implant employing a gingival attachment device according to one embodiment of the invention by which bone resorption is prevented;

FIGS. 3A and 3B are schematic top views of two embodiments, respectively, of a gingival attachment device;

FIG. 4A is a perspective view of another embodiment of a gingival attachment device, and FIG. 4B is a side view thereof;

FIG. 5A is a perspective view of another embodiment of a gingival attachment device, and FIG. 5B is a side view thereof; and

FIG. 6A is a perspective view of another embodiment of a gingival attachment device, and FIGS. 6B and 6C are front and side views, respectively, thereof.

### DETAILED DESCRIPTION OF PREFERRED EMBODIMENTS

An aesthetically pleasing smile is facilitated by proper management of the soft tissues around natural teeth and implants. An optimal aesthetic configuration of the gingiva including the papilla surrounding an implant crown is usually difficult to achieve in most cases.

The present invention comprises a device that promotes the attachment of gingival tissue to the implant. The device is provided with a biocompatible and non-degradable polymeric scaffold specifically at the cervical part of the implant above the bone crest. This device restores the correct tissue orientation at the implant-cell interfaces and as a result restores the architecture of marginal gingival including papillae. Also, the attachment of the gingival tissue to the implant generates physiological tensile forces that are directed toward the crown, thus inhibiting crestal bone remodeling and bone loss.

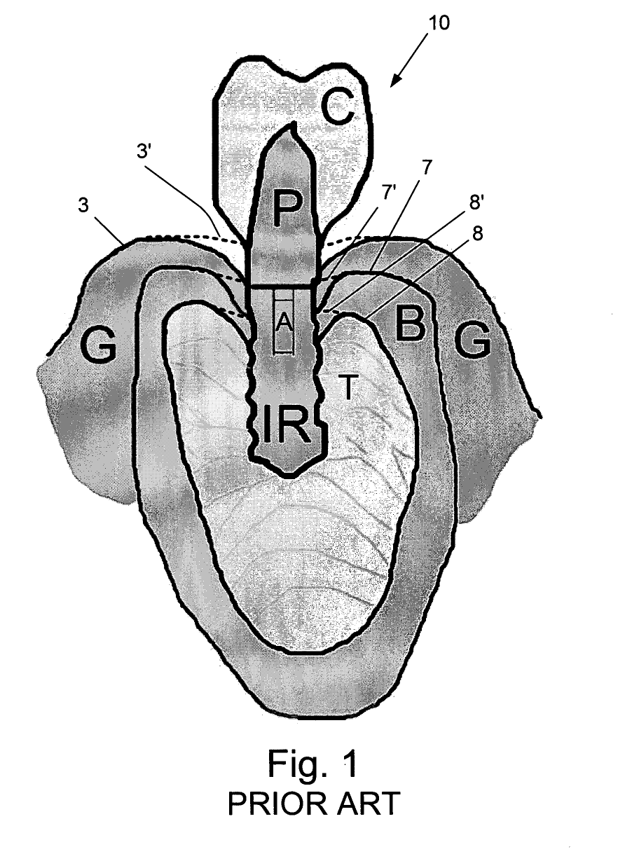

In order to appreciate the utility of the present invention, reference is first made to FIG. 1, which schematically illustrates the occurrence of bone resorption resulting from the employment of a prior art dental implant.

As shown, a prior art dental implant designated generally by numeral 10 comprises implant root IR anchored to compact cortical bone B and to the softer trabecular bone T having interstices filled with bone marrow which is internal to cortical bone B, post P coupled to root IR by attachment means A and protruding through gingiva G covering cortical bone B, and crown C which is mounted on post P. Implant root IR and post P are generally made from titanium, and the visible crown C is generally made materials such as white and aesthetically pleasing zirconium, ceramic materials, ceramic materials bonded to gold, or composite materials.

Gingiva G is composed of two layers: the outer epithelium layer and the inner connective tissue layer containing fibroblasts. Gingiva G is normally attached to a tooth by Sharpey fibers at a gingiva-tooth interface represented by dashed line 3 and to cortical bone B at a gingiva-bone interface represented by dashed line 7. During implantation of implant 10, however, the epithelium and connective tissue are wounded. As the wound heals, epithelial cells adhere to one another, proliferating coronally with respect to the blood clot or to fibrin to thereby seal the wound gap, and connective tissue cells adhere to one another and to extracellular matrix (ECM) as a result of the interaction by the fibrillar protein meshwork, including collagen, fibronectin and fibrin, with the newly formed blood clot. Since the gingival tissue does not become attached to metallic post P due to the lack of receptors therein, gingiva G tends to become attached to cortical bone B. The coronal surface of gingival G therefore recedes from a substantially straight line 3 to a downward sloping curve 3′. Signal transducing molecules respond to the lack of the normally found tensile forces within the disoriented gingival G by removing the ECM in the vicinity of cortical bone B, resulting in the resorption of the latter whereby the coronal surface of cortical bone B recedes from a substantially straight line 7 to a downwardly sloping curve 7′. Likewise resorption occurs in trabecular bone T, whereby the coronal surface of trabecular bone T recedes from a substantially straight line 8 to a downward sloping curve 8′.

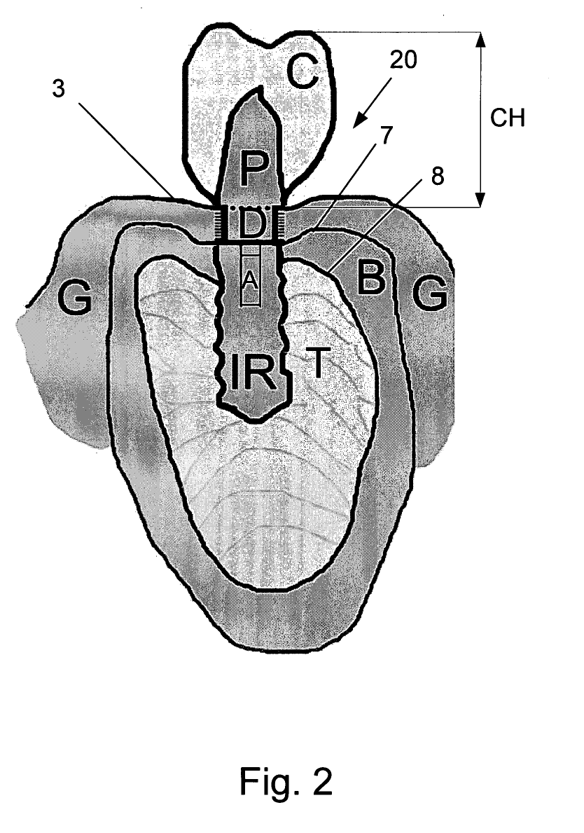

FIG. 2 schematically illustrates a dental implant according to one embodiment of the present invention, which is designated generally by numeral 20. Implant 20 comprises implant root IR anchored to cortical bone B and to trabecular bone T, post P coupled to root IR by attachment means A and protruding through gingiva G covering cortical bone B, crown C mounted on post P, and gingival attachment device D. Gingival attachment device D is mounted in surrounding fashion on a cervically located portion of post P, on the coronal surface of the implant root IR. As referred to herein, a “cervically located portion” means a portion that is located between crown C and implant root IR and adjoins the crest, i.e. the coronal portion, of cortical bone B. The cervix of post P may be narrower than another portion thereof or may have substantially the same thickness. Gingival attachment device D may have substantially the same height as that of the peri-implant gingiva G as shown, or may have a smaller height than the peri-implant gingiva G. Since gingival attachment device D is configured with material that is adapted to attract gingiva G thereto to achieve its normal tensegrity, signal transducing molecules do not act to remove any ECM. Consequently gingival G, cortical bone B and trabecular bone T are therefore able to retain their normal shape of lines 3, 7, and 8, respectively.

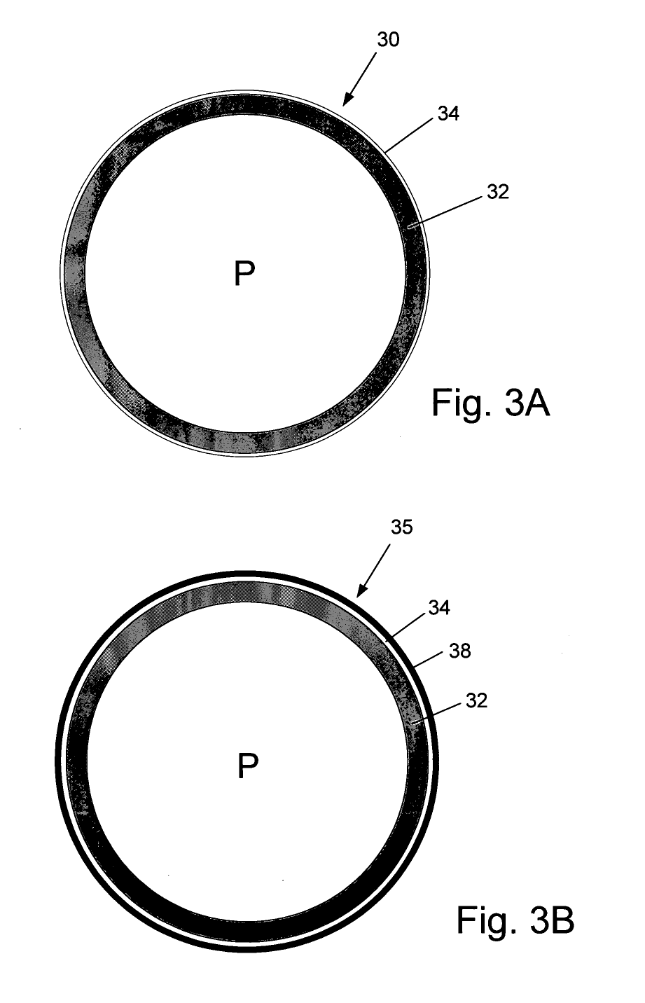

FIG. 3A illustrates a top view of gingival attachment device 30 according to one embodiment of the invention. Gingival attachment device 30 comprises an annular frame 32 made of gold, titanium, palladium, zirconium, gold palladium alloys, or gold platinum alloys, and having a uniform height of 1-6 mm. The inner diameter of frame 32 is selected in accordance with the diameter of the implant root. That is, if the outer diameter of implant root IR (FIG. 2) is relatively wide, post P and gingival attachment device 30 mounted by a small tolerance press fit onto a cervically located portion of post P will also have a correspondingly long outer diameter. The thickness of the annular frame ranges from 1-2 mm, depending on the diameter of implant root IR. On the entire gingival facing surface of the metallic frame 32 is applied a polymer coating 34 having a thickness ranging from 0.1-2.0 mm.

Polymer coating 32 is a stable, biocompatible and non-degradable polymeric scaffold to which epithelial and connective tissue cells of the gingiva are attachable, and may have hydrophilic properties. The polymeric scaffold may be polyvinylpyrronidole mixed with butyl-methylmethacrylate, silk fibroin fibrous protein polymer mixed with chitosan or with its derivatives, or polyHEMA. The polymeric scaffold promotes the attachment of gingival and periosteal fibroblasts to gingival attachment device 30 by a long lasting biological bond. Gingival fibroblasts are therefore directed to both the coronal and apical portions of gingival attachment device 30. The form of the crestal cortical bone is maintained, and even additional cortical bone may be generated. As a result of the biointegrated attachment, gingival fibroblasts are anchored to gingival attachment device 30, forming a biological seal with respect to interproximal food debris and generating tensile forces that are directed toward gingival attachment device 30 and post P.

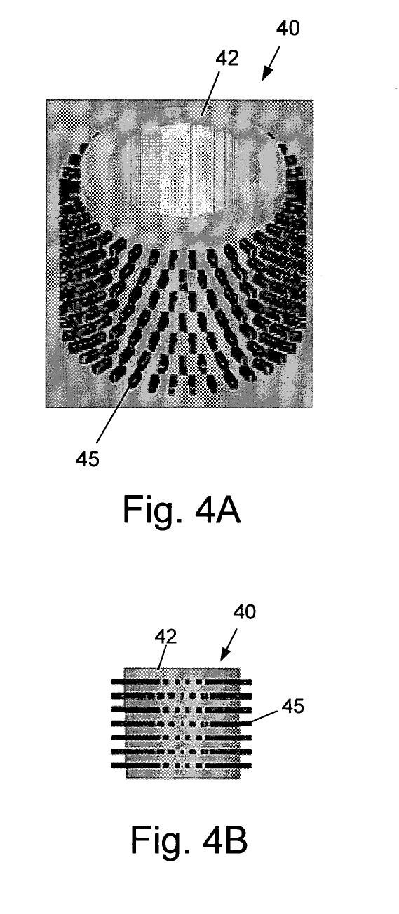

FIG. 4A illustrates a perspective view of gingival attachment device 40, and FIG. 4B illustrates a side view thereof. Gingival attachment device 40 comprises tubular frame 42, the polymeric coating applied to frame 42 (not shown), and a plurality of radially extending fibers 45 attached to the polymer coating, along the entire periphery thereof. Fibers 34 having a length ranging from 0.1-1.0 mm and a thickness ranging from 20-100 microns are made of a biocompatible cell adherent, such as collagen, polymer coated with fibronectin or with receptors of gingival fibroblast integrins, or a combination thereof. Fibers 45 may be uniformly interspersed by a spacing ranging from 100-500 microns along the periphery of the polymer-coated frame 42, or may be attached thereto in any other suitable arrangement. The cell adherent may also be in the form of membrane sheaths.

The fibrous biomaterial conditions of fibers 45 attract and induce attachment thereto of gingival fibroblasts in an orderly manner, forming a pattern of tissue architecture similar to that of natural dentition. After cell attachment, strained fibroblasts will become aligned along the mesh of fibrous matrix characterized by the plurality of fibers 45 protruding from frame 42. These strains stimulate the growth of the periosteum and the crestal bone toward gingival attachment device 40, therefore producing a mechanical-biological connection with the latter and helping to develop new gingival tissue including the papilla. The gingival fibroblasts will become attached to the polymeric coating if fibers 45 or the membrane sheaths hosting the cell adherent will become degraded.

In another embodiment, polymer coating 34 shown in FIG. 3A is a thin coating of polymer, e.g. having a thickness of 0.5 mm, in which fibrils or membrane sheaths are embedded within the same type of polymer that is coated on frame 42, or within another suitable porous, stable polymeric coating. A porous polymeric scaffold based on bulk-copolymerization of 1-vinyl-2-pyrrolidinone (NVP) and n-butyl methacrylate (BMA), followed by a particulate-leaching step to generate porosity is described by E. Jansen et al, “Hydrophobocity as a Design Criterion for Polymer Scaffolds in Bone Tissue Engineering,” J. Biomaterials, 2004.11.011. A similar polymeric scaffold will support in vivo three-dimensional tissue in-growth, vascularization, and biointegration with gingival tissue.

In another embodiment shown in FIG. 3B, gingival attachment device 35 comprises annular frame 32, primary polymer coating 34 which is applied to frame 32 and a secondary coating 38 applied to primary coating 34. The coronal portion, e.g. for a height of 1-2 mm, of secondary coating 38 is coated with molecules, such as enamel proteins, fibrin, collagen Type IV, laminin or fragments thereof, which attract and promote the adherence of epithelial cells thereto. The apical portion of secondary coating 38 is coated with molecules, such as collagen Type I, fibronectin, fibrin, fragments thereof, RGD or RGDS peptides (Arginine, Glycine, Aspargine and Serine), and receptors for integrins, to promote the adherence thereto of gingival fibroblasts. The molecules of secondary coating 38 are adapted to produce tensile traction forces within the epithelial and connective tissue cells.

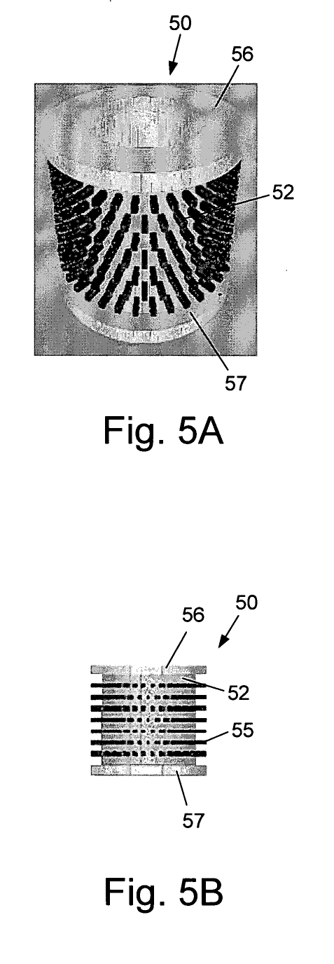

FIG. 5A illustrates a perspective view of gingival attachment device 50, and FIG. 5B illustrates a side view thereof. In this embodiment, gingival attachment device 50 comprises coronal cover element 56 and apical cover element 57, in addition to frame 52, the polymeric coating applied to frame 52 (not shown), and the plurality of radially extending fibers 55. Elements 56 and 57 are attached to the coronal and apical ends, respectively, of frame 52, and have substantially the same radial dimension as fibers 55. Elements 56 and 57 are preferably made from the same material as the polymeric coating.

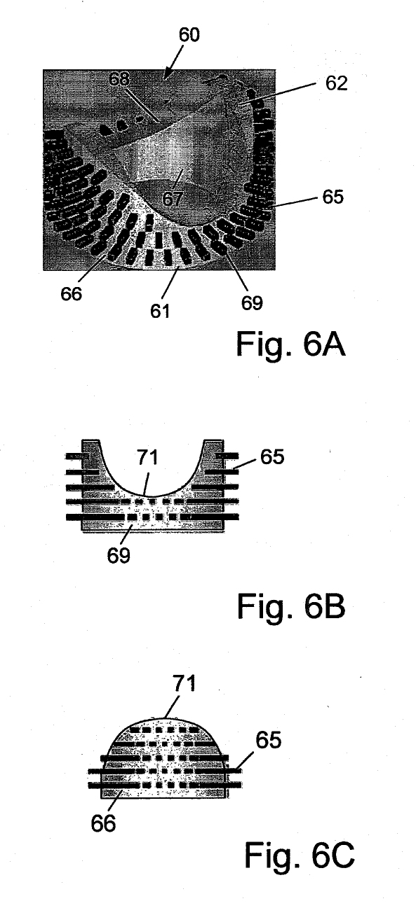

FIG. 6A illustrates a perspective view of gingival attachment device 60, and FIGS. 6B and 6C illustrate two side views thereof. In this embodiment, frame 62 has a non-uniform height ranging from 2-7 mm. Frame 62, which has an annular horizontal cross section, i.e. having a circular or oval outer surface, and a planar apical edge 61, has interproximal portions 66 and 67 that have a greater height than lingual portion 68 and buccal portion 69. Coronal edge 71 of frame 62 is curvilinear, without any sharp edges, configured such that it is concave with respect to buccal portion 69 as shown in FIG. 6B and that it is convex with respect to interproximal portion 66 as shown in FIG. 6C. A polymer coating is applied to the gingival facing surface of frame 62, and fibers 65 extend radially from the polymer coating. The height of buccal portion 69 ranges from 1-3 mm and that of lingual portion ranges from 2-5 mm, following the natural gingival contour. The height of interproximal portions 66 and 67, each of which is instrumental in determining the height of the corresponding papilla, ranges from 2-7 mm.

By employing gingival attachment device 60, a dentist may advantageously select the dimensions of an attachment device in accordance with the configuration of the natural dentition. As explained hereinabove, the papilla is formed at, and attached to, interproximal portions 66 and 67. Since the existence of a papilla influences the appearance of an aesthetically pleasing smile and prevents the manifestation of the black hole disease, a dentist may manage the formation of the gingiva by properly selecting the dimensions of an attachment device.

The dentist first selects crown height CH (FIG. 2) of the implant crown C prior to selecting the suitable gingival attachment device 60. The height of a papilla ranges from 40-70% of the crown height of a dental implant, and preferably up to half of the crown height, similar to the height proportion between a papilla and the corresponding crown of a naturally found tooth. Thus the height of interproximal portions 66 and 67 is dependent on the implant crown height CH. Clinical judgment dictates the height of an interproximal portion which is interposed between two teeth of a different crown height. The dentist then visually inspects the gingiva, to determine the thickness thereof. Based on this thickness, the height of buccal portion 69 is selected. The height of lingual portion 68 is then selected.

While some embodiments of the invention have been described by way of illustration, it will be apparent that the invention can be carried out with many modifications, variations and adaptations, and with the use of numerous equivalents or alternative solutions that are within the scope of persons skilled in the art, without departing from the spirit of the invention or exceeding the scope of the claims.

What we claim is:

1. A gingival cell attachment device associated with or part of an endosseous implant, which comprises a cervically located component of a dental implant coated on a gingival facing surface thereof with a biocompatible and non-degradable polymeric scaffold to which epithelial and connective tissue cells of the gingiva are chemically and physically attachable.

2. The attachment device according to claim 1, wherein the polymeric scaffold is selected from the group consisting of:
polyvinylpyrronidole mixed with butyl-methylmethacrylate, silk fibroin fibrous protein polymer mixed with one of:
chitosan and
derivatives of chitosan, and
polyHEMA.

3. The attachment device according to claim 1, wherein the polymeric scaffold is a porous polymeric scaffold.

4. The attachment device according to claim 1, wherein the polymeric scaffold comprises a primary polymer coating applied to the cervically located component and a secondary coating applied to said primary coating.

5. The attachment device according to claim 4, wherein the apical portion is coated with molecules selected from the group consisting of collagens, fibronectin, fibrin, fragments thereof, RGD peptides, or RGDS peptides, and receptors for integrins.

6. The attachment device according to claim 1, wherein the plurality of fibers are attached to at least a partial periphery of the polymeric scaffold.

7. The attachment device according to claim 6, wherein the fibers comprise a cell adherent selected from the group consisting of collagens, silk fibroin, and silica gel coated with receptors of gingival fibroblast integrins, fibronectin and a combination thereof.

8. The attachment device according to claim 1, wherein the cervically located component includes an annular component comprising a metallic frame which is mountable on a cervically located region of an implant post.

9. The attachment device according to claim 8, wherein the frame is made of a metal selected from the group consisting of gold, titanium, palladium, zirconium, gold palladium alloys, and biocompatible alloys.

10. The attachment device according to claim 8, wherein the frame has one of:
a uniform height, and
a non-uniform height.

11. A method for gingiva management, comprising the steps of:
a) providing a plurality of gingival attachment devices, each of said devices comprising a metallic annular frame formed with interproximal portions having a greater height than a lingual portion and a buccal portion and with a curvilinear coronal edge, and a biocompatible and non-degradable polymeric scaffold coated on all gingival facing surfaces of said frame, to which epithelial and connective tissue cells of the gingiva are attachable;
b) measuring the crown height of a dental implant;
c) selecting a gingival attachment device having an interproximal portion of a height equal to a value ranging from to 70 percent of said measured crown height; and
d) mounting said selected attachment device on a post of said implant.

12. (canceled)

13. (canceled)
